(19) United States
(12) Patent Application Publication
(10) Pub. No.: US 2013/0260032 A1
(43) Pub. Date: Oct. 3, 2013

(54) Process for Thermal Postcrosslinking in a Drum Heat Exchanger with an Inverse Screw Helix

(71) Applicant: BASF SE, Ludwigshafen (DE)

(72) Inventors: Holger Barthel, Oftersheim (DE); Gerald Gruenewald, Ludwigshafen (DE); Norbert Herfert, Altenstadt (DE); Markus Muehl, Mommenheim (DE); Birgit Reinhard, Limburgerhof (DE)

(73) Assignee: BASF SE, Ludwigshafen (DE)

(21) Appl. No.: 13/848,879

(22) Filed: Mar. 22, 2013

Related U.S. Application Data
(60) Provisional application No. 61/617,687, filed on Mar. 30, 2012.

(51) Int. Cl. B01J 20/32

(52) U.S. Cl. CPC B01J 20/3225
USPC 427/213.33; 422/137

(57) ABSTRACT

A process for thermal surface postcrosslinking of water-absorbing polymer particles, wherein the polymer particles are coated with an aqueous solution, the coated polymer particles are deagglomerated and the deagglomerated polymer particles are thermally surface postcrosslinked by means of a drum heat exchanger with an inverse screw helix.

The present invention relates to a process for thermal surface postcrosslinking of water-absorbing polymer particles, wherein the polymer particles are coated with an aqueous solution, the coated polymer particles are deagglomerated and the deagglomerated polymer particles are thermally surface postcrosslinked by means of a drum heat exchanger with an inverse screw helix.

Water-absorbing polymer particles are used to produce diapers, tampons, sanitary napkins and other hygiene articles, but also as water-retaining agents in market gardening. The water-absorbing polymer particles are also referred to as superabsorbents.

The production of water-absorbing polymer particles is described in the monograph “Modern Superabsorbent Polymer Technology”, F. L. Buchholz and A. T. Graham, Wiley-VCH, 1998, pages 71 to 103.

The properties of the water-absorbing polymer particles can be adjusted, for example, via the amount of crosslinker used. With an increasing amount of crosslinker, the centrifuge retention capacity (CRC) falls and the absorption under a pressure of 21.0 g/cm² (AUL0.3 psi) passes through a maximum.

To improve the use properties, for example permeability of the swollen gel bed (SFC) in the diaper and absorption under a pressure of 49.2 g/cm² (AUL0.7 psi), water-absorbing polymer particles are generally surface postcrosslinked. This increases the level of crosslinking of the particle surface, which can at least partly decouple the absorption under a pressure of 49.2 g/cm² (AUL0.7 psi) and the centrifuge retention capacity (CRC). This surface postcrosslinking can be performed in aqueous gel phase. Preferably, however, dried, ground and sieved polymer particles (base polymer) are surface coated with a surface postcrosslinker and thermally surface postcrosslinked. Crosslinkers suitable for that purpose are compounds which can form covalent bonds to at least two carboxylate groups of the water-absorbing polymer particles.

EP 1 757 645 A1 and EP 1 757 646 A1 disclose the surface postcrosslinking of water-absorbing polymer particles in a rotary tube.

DE 10 2007 024 080 A1 teaches the aftertreatment of water-absorbing polymer particles, for example with water, in a rotating vessel.

It was an object of the present invention to provide an improved process for producing water-absorbing polymer particles, more particularly improved surface postcrosslinking.

The object was achieved by processes for thermal surface postcrosslinking of water-absorbing polymer particles, the water-absorbing polymers being produced by polymerizing an aqueous monomer solution or suspension comprising

a) at least one ethylenically unsaturated monomer which bears acid groups and may be at least partly neutralized,

b) at least one crosslinker,

c) at least one initiator,

d) optionally one or more ethylenically unsaturated monomers copolymerizable with the monomers mentioned under a) and

e) optionally one or more water-soluble polymers,

which comprises coating the polymer particles with an aqueous solution, deagglomerating the coated polymer particles and thermally surface postcrosslinking the deagglomerated polymer particles by means of a drum heat exchanger with an inverse screw helix.

Advantageously, the coating and the deagglomeration are conducted in a horizontal mixer, or the coating in a vertical mixer and the deagglomeration in a horizontal mixer.

In a preferred embodiment of the present invention, the coated polymer particles are dried or heated during the deagglomeration.

The fill level of the drum heat exchanger is preferably 30 to 100%, more preferably 40 to 95%, most preferably 65 to 90%, based in each case on the height of the screw helix.

The temperature of the water-absorbing polymer particles in the drum heat exchanger is preferably from 120 to 220° C., more preferably from 150 to 210° C., most preferably from 170 to 200° C., and/or the residence time of the water-absorbing polymer particles in the drum heat exchanger is preferably from 10 to 120 minutes, more preferably from 20 to 90 minutes, most preferably from 30 to 60 minutes.

The drum heat exchanger is typically heated electrically or with steam, preferably indirectly. “Indirectly heated” means that the heating is effected through the wall of the rotating drum.

The present invention further provides apparatuses suitable for the performance of the process according to the invention. These are, more particularly, an apparatus for thermal surface postcrosslinking of water-absorbing polymer particles, comprising a heatable horizontal mixer and a drum heat exchanger with an inverse screw helix, and an apparatus for thermal surface postcrosslinking of water-absorbing polymer particles, comprising a vertical mixer, a heatable horizontal mixer and a drum heat exchanger with an inverse screw helix.

Heatable horizontal mixer and drum heat exchanger, or vertical mixer, heatable horizontal mixer and drum heat exchanger, are preferably connected in direct succession.

In a preferred embodiment of the present invention, a coolable horizontal mixer is connected directly downstream of the drum heat exchanger.

“Connected in direct succession” and “connected directly downstream” mean that the discharge from one apparatus passes to the next apparatus by a very short route and without intermediate storage.

The present invention is based on the finding that the outcome of the thermal surface postcrosslinking is influenced very strongly by the residence time. Especially in the case of water-absorbing polymer particles produced by dropletization of a monomer solution, the permeability of the swollen gel bed (SFC) passes through a pronounced maximum.

Thermal surface postcrosslinking in a drum heat exchanger with an inverse screw helix enables continuous thermal surface postcrosslinking with narrow residence time distribution; virtually no backmixing takes place between the individual helices given correct loading. The proportion of water-absorbing polymer particles with excessively low and excessively high residence time and hence inadequate quality can thus be minimized.

The production of the water-absorbing polymer particles and the invention are described in detail hereinafter:

The water-absorbing polymer particles are produced by polymerizing a monomer solution or suspension, and are typically water-insoluble.

The monomers a) are preferably water-soluble, i.e. the solubility in water at 23° C. is typically at least 1 g/100 g of water, preferably at least 5 g/100 g of water, more preferably at least 25 g/100 g of water and most preferably at least 35 g/100 g of water.

Suitable monomers a) are, for example, ethylenically unsaturated carboxylic acids, such as acrylic acid, methacrylic acid and itaconic acid. Particularly preferred monomers are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

It is also possible to use a plurality of monomers a), for example mixtures of acrylic acid and 2-acrylamido-2-methylpropanesulfonic acid.

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 and comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The proportion of acrylic acid and/or salts thereof in the total amount of monomers a) is preferably at least 50 mol %, more preferably at least 90 mol %, most preferably at least 95 mol %.

The monomers a) typically comprise polymerization inhibitors, preferably hydroquinone monoethers, as storage stabilizers.

The monomer solution comprises preferably up to 250 ppm by weight, preferably at most 130 ppm by weight, more preferably at most 70 ppm by weight, and preferably at least 10 ppm by weight, more preferably at least 30 ppm by weight and especially around 50 ppm by weight, of hydroquinone monoether, based in each case on the unneutralized monomer a). For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301A1 and DE 103 31 450 A1, mixed acrylates which, as well as acrylate groups, comprise further ethylenically unsaturated groups, as described in DE 103 31 456 A1 and DE 103 55 401A1, or crosslinker mixtures, as described, for example, in DE 195 43 368 A1, DE 196 46 484 A1, WO 90/15830 A1 and WO 2002/032962 A2.

Preferred crosslinkers b) are pentaerythrityl triallyl ether, tetraallyloxyethane, methylenebismethacrylamide, 15-tuply ethoxylated trimethylolpropane triacrylate, polyethylene glycol diacrylate, trimethylolpropane triacrylate and triallylamine.

Very particularly preferred crosslinkers b) are the polyethoxylated and/or -propoxylated glycerols which have been esterified with acrylic acid or methacrylic acid to give di- or triacrylates, as described, for example, in WO 2003/104301A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably 0.05 to 1.5% by weight, more preferably 0.1 to 1% by weight and most preferably 0.2 to 0.6% by weight, based in each case on monomer a).

The initiators c) used may be all compounds which generate free radicals under the polymerization conditions, for example thermal initiators, redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. The reducing component used is, however, preferably a mixture of the sodium salt of 2-hydroxy-2-sulfinatoacetic acid, the disodium salt of 2-hydroxy-2-sulfonatoacetic acid and sodium bisulfite. Such mixtures are obtainable as Brüggolite® FF6 and Brüggolite® FF7 (Bruggemann Chemicals; Heilbronn; Germany). It is also possible to use the disodium salt of 2-hydroxy-2-sulfonatoacetic acid alone as the reducing component.

Ethylenically unsaturated monomers d) copolymerizable with the ethylenically unsaturated monomers a) bearing acid groups are, for example, acrylamide, methacrylamide, hydroxyethyl acrylate, hydroxyethyl methacrylate, dimethylaminoethyl methacrylate, dimethylaminoethyl acrylate, dimethylaminopropyl acrylate, diethylaminopropyl acrylate, dimethylaminoethyl methacrylate, diethylaminoethyl methacrylate.

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight and most preferably from 50 to 65% by weight. It is also possible to use monomer suspensions, i.e. monomer solutions with excess monomer a), for example sodium acrylate. With rising water content, the energy requirement in the subsequent drying rises, and, with falling water content, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors are, for example, kneading reactors or belt reactors. In the kneader, the polymer gel formed in the polymerization of an aqueous monomer solution or suspension is comminuted continuously by, for example, contrarotatory stirrer shafts, as described in WO 2001/038402 A1. Polymerization on the belt is described, for example, in DE 38 25 366 A1 and U.S. Pat. No. 6,241,928. Polymerization in a belt reactor forms a polymer gel which has to be comminuted in a further process step, for example in an extruder or kneader.

To improve the drying properties, the comminuted polymer gel obtained by means of a kneader can additionally be extruded.

However, it is also possible to dropletize an aqueous monomer solution and to polymerize the droplets obtained in a heated carrier gas stream. It is possible here to combine the process steps of polymerization and drying, as described in WO 2008/040715 A2, WO 2008/052971A1 and WO 2011/026876 A1.

The acid groups of the resulting polymer gels have typically been partially neutralized. Neutralization is preferably carried out at the monomer stage. This is typically accomplished by mixing in the neutralizing agent as an aqueous solution or preferably also as a solid. The degree of neutralization is preferably from 25 to 95 mol %, more preferably from 30 to 80 mol % and most preferably from 40 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof.

However, it is also possible to carry out neutralization after the polymerization, at the stage of the polymer gel formed in the polymerization. It is also possible to neutralize up to 40 mol %, preferably 10 to 30 mol % and more preferably 15 to 25 mol % of the acid groups before the polymerization by adding a portion of the neutralizing agent directly to the monomer solution and setting the desired final degree of neutralization only after the polymerization, at the polymer gel stage. When the polymer gel is neutralized at least partly after the polymerization, the polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

The polymer gel is then preferably dried with a belt drier until the moisture content is preferably 0.5 to 15% by weight, more preferably 1 to 10% by weight and most preferably 2 to 8% by weight, the moisture content being determined by EDANA recommended test method No. WSP 230.2-05 “Mass Loss Upon Heating”. In the case of too high a moisture content, the dried polymer gel has too low a glass transition temperature T_{g} and can be processed further only with difficulty. In the case of too low a moisture content, the dried polymer gel is too brittle and, in the subsequent comminution steps, undesirably large amounts of polymer particles with an excessively low particle size are obtained (“fines”). The solids content of the gel before the drying is preferably from 25 to 90% by weight, more preferably from 35 to 70% by weight and most preferably from 40 to 60% by weight. However, a fluidized bed drier or a paddle drier may optionally also be used for drying purposes.

Thereafter, the dried polymer gel is ground and classified, and the apparatus used for grinding may be multistage roll mills, preferably two- or three-stage roll mills, pin mills, hammer mills or vibratory mills.

The mean particle size of the polymer particles removed as the product fraction is preferably at least 200 μm, more preferably from 250 to 600 μm and very particularly from 300 to 500 μm. The mean particle size of the product fraction may be determined by means of EDANA recommended test method No. WSP 220.2-05 “Particle Size Distribution”, where the proportions by mass of the screen fractions are plotted in cumulated form and the mean particle size is determined graphically. The mean particle size here is the value of the mesh size which gives rise to a cumulative 50% by weight.

The proportion of particles having a particle size of greater than 150 μm is preferably at least 90% by weight, more preferably at least 95% by weight and most preferably at least 98% by weight.

Polymer particles with too small a particle size lower the permeability (SFC). The proportion of excessively small polymer particles (“fines”) should therefore be low.

Excessively small polymer particles are therefore typically removed and recycled into the process. This is preferably done before, during or immediately after the polymerization, i.e. before the drying of the polymer gel. The excessively small polymer particles can be moistened with water and/or aqueous surfactant before or during the recycling.

It is also possible to remove excessively small polymer particles in later process steps, for example after the surface postcrosslinking or another coating step. In this case, the excessively small polymer particles recycled are surface postcrosslinked or coated in another way, for example with fumed silica.

When a kneading reactor is used for polymerization, the excessively small polymer particles are preferably added during the last third of the polymerization.

When the excessively small polymer particles are added at a very early stage, for example actually to the monomer solution, this lowers the centrifuge retention capacity (CRC) of the resulting water-absorbing polymer particles. However, this can be compensated for, for example, by adjusting the amount of crosslinker b) used.

When the excessively small polymer particles are added at a very late stage, for example not until an apparatus connected downstream of the polymerization reactor, for example an extruder, the excessively small polymer particles can be incorporated into the resulting polymer gel only with difficulty. Insufficiently incorporated, excessively small polymer particles are, however, detached again from the dried polymer gel during the grinding, are therefore removed again in the course of classification and increase the amount of excessively small polymer particles to be recycled.

The proportion of particles having a particle size of at most 850 μm is preferably at least 90% by weight, more preferably at least 95% by weight, most preferably at least 98% by weight.

The proportion of particles having a particle size of at most 600 μm is preferably at least 90% by weight, more preferably at least 95% by weight, most preferably at least 98% by weight.

Polymer particles with excessively large particle size lower the free swell rate. The proportion of excessively large polymer particles should therefore likewise be small.

Excessively large polymer particles are therefore typically removed and recycled into the grinding of the dried polymer gel.

To further improve the properties, the polymer particles are surface postcrosslinked. Suitable compounds are, for example, polyfunctional amines, polyfunctional amido amines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

Additionally described as suitable surface postcrosslinkers are cyclic carbonates in DE 40 20 780 C1,2-oxazolidinone and derivatives thereof, such as 2-hydroxyethyl-2-oxazolidinone, in DE 198 07 502 A1, bis- and poly-2-oxazolidinones in DE 198 07 992 C1, 2-oxotetrahydro-1,3-oxazine and derivatives thereof in DE 198 54 573 A1, N-acyl-2-oxazolidinones in DE 198 54 574 A1, cyclic ureas in DE 102 04 937 A1, bicyclic amide acetals in DE 103 34 584 A1, oxetanes and cyclic ureas in EP 1 199 327 A2 and morpholine-2,3-dione and derivatives thereof in WO 2003/031482 A1.

Preferred surface postcrosslinkers are ethylene carbonate, ethylene glycol diglycidyl ether, reaction products of polyamides with epichlorohydrin and mixtures of propylene glycol and 1,4-butanediol.

Very particularly preferred surface postcrosslinkers are 2-hydroxyethyl-2-oxazolidinone, 2-oxazolidinone and 1,3-propanediol.

In addition, it is also possible to use surface postcrosslinkers which comprise additional polymerizable ethylenically unsaturated groups, as described in DE 37 13 601 A1.

The amount of surface postcrosslinker is preferably 0.001 to 2% by weight, more preferably 0.02 to 1% by weight and most preferably 0.05 to 0.2% by weight, based in each case on the polymer particles.

In a preferred embodiment of the present invention, polyvalent cations are applied to the particle surface in addition to the surface postcrosslinkers before, during or after the surface postcrosslinking.

The polyvalent cations usable in the process according to the invention are, for example, divalent cations such as the cations of zinc, magnesium, calcium, iron and strontium, trivalent cations such as the cations of aluminum, iron, chromium, rare earths and manganese, tetravalent cations such as the cations of titanium and zirconium. Possible counterions are hydroxide, chloride, bromide, sulfate, hydrogensulfate, carbonate, hydrogencarbonate, nitrate, phosphate, hydrogenphosphate, dihydrogenphosphate and carboxylate, such as acetate, citrate and lactate. Salts with different counterions are also possible, for example basic aluminum salts such as aluminum monoacetate or aluminum monolactate. Aluminum sulfate, aluminum monoacetate and aluminum lactate are preferred. Apart from metal salts, it is also possible to use polyamines as polyvalent cations.

The amount of polyvalent cation used is, for example, 0.001 to 1.5% by weight, preferably 0.005 to 1% by weight and more preferably 0.02 to 0.8% by weight, based in each case on the polymer particles.

The surface postcrosslinking is typically conducted in such a way that the dried polymer particles are coated with an aqueous solution of the surface postcrosslinker, for example by spraying the solution onto the polymer particles. Thereafter, the polymer particles coated with surface postcrosslinker are deagglomerated and thermally surface postcrosslinked.

The coating with the solution of the surface postcrosslinker is preferably performed in mixers with moving mixing tools, such as screw mixers, disk mixers and paddle mixers. Suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; USA) and Schugi Flexomix® (Hosokawa Micron BV; Doetinchem; the Netherlands). It is also possible to spray on the solution in a fluidized bed.

The deagglomeration is likewise preferably performed in mixers with moving mixing tools, such as screw mixers, disk mixers and paddle mixers. Advantageously suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands) and Processall Mixmill mixers (Processall Incorporated; Cincinnati; USA).

When coated with aqueous solutions, the water-absorbing polymer particles tend to form lumps (agglomeration). In a vertical mixer, the water-absorbing polymer particles have a lower tendency to form lumps when coated. The coating is therefore advantageously performed in a vertical mixer. In addition, the agglomerates formed can be broken up again by moderate mechanical stress. For this purpose, horizontal mixers are of better suitability due to the higher residence time. It is therefore also possible to perform coating and deagglomeration in a horizontal mixer. The distinction between horizontal mixers and vertical mixers is made by the position of the mixing shaft, i.e. horizontal mixers have a horizontally mounted mixing shaft and vertical mixers a vertically mounted mixing shaft.

The surface postcrosslinkers are used in the form of an aqueous solution. The penetration depth of the surface postcrosslinker into the polymer particles can be adjusted via the content of nonaqueous solvent and total amount of solvent.

When exclusively water is used as the solvent, a surfactant is advantageously added. This improves the wetting behavior and reduces the tendency to form lumps. However, preference is given to using solvent mixtures, for example isopropanol/water, 1,3-propanediol/water and propylene glycol/water, where the mixing ratio in terms of mass is preferably from 20:80 to 40:60.

Advantageously, the water-absorbing polymer particles are also dried and/or heated prior to the thermal surface postcrosslinking. This is preferably done actually during the deagglomeration, preferably in contact driers, such as paddle driers and disk driers. Suitable contact driers are, for example, Hosokawa Bepex® Horizontal Paddle Dryers (Hosokawa Micron GmbH; Leingarten; Germany), Hosokawa Bepex® Disc Dryers (Hosokawa Micron GmbH; Leingarten; Germany), Holo-Flite® driers (Metso Minerals Industries Inc.; Danville; USA) and Nara Paddle Dryers (NARA Machinery Europe; Frechen; Germany).

The coating with the aqueous solution increases the water content of the water-absorbing polymer particles. This relatively high water content is a barrier to thermal surface postcrosslinking at relatively high temperatures. It is therefore advantageous to dry the water-absorbing polymer particles and to heat them to the reaction temperature prior to the thermal surface postcrosslinking.

The water content of the coated and deagglomerated polymer particles prior to the thermal surface postcrosslinking is preferably less than 5% by weight, more preferably less than 2% by weight and most preferably less than 1% by weight.

After the deagglomeration, the optionally dried and/or heated polymer particles are transferred, for thermal surface postcrosslinking, into a drum heat exchanger with an inverse screw helix.

A drum heat exchanger with an inverse screw helix is a heatable, recumbent and rotatable drum, wherein an inverse screw helix for forced conveying of the product is integrated into the inner wall of the drum. The drum can, for example, be heated indirectly via the drum wall. Typically, the heating is effected electrically or with steam. Using a plurality of independent heating zones along the longitudinal axis of the drum, various wall temperatures can be established in the drum.

Direct product heating in the interior of the drum heat exchanger by installation of a burner or the introduction of hot flue gases is typically not employed here.

Where a very homogeneous radial temperature distribution of the product in the drum is required, it is possible, in addition to the inverse screw helix, to install radial mixing elements (for example in the form of entraining paddles or elements) on the periphery of the inner drum wall. These promote the radial mixing of the product within the separate zones which form due to the inverse screw helix and are used especially when working with a large drum diameter and high fill level or height of the screw helix.

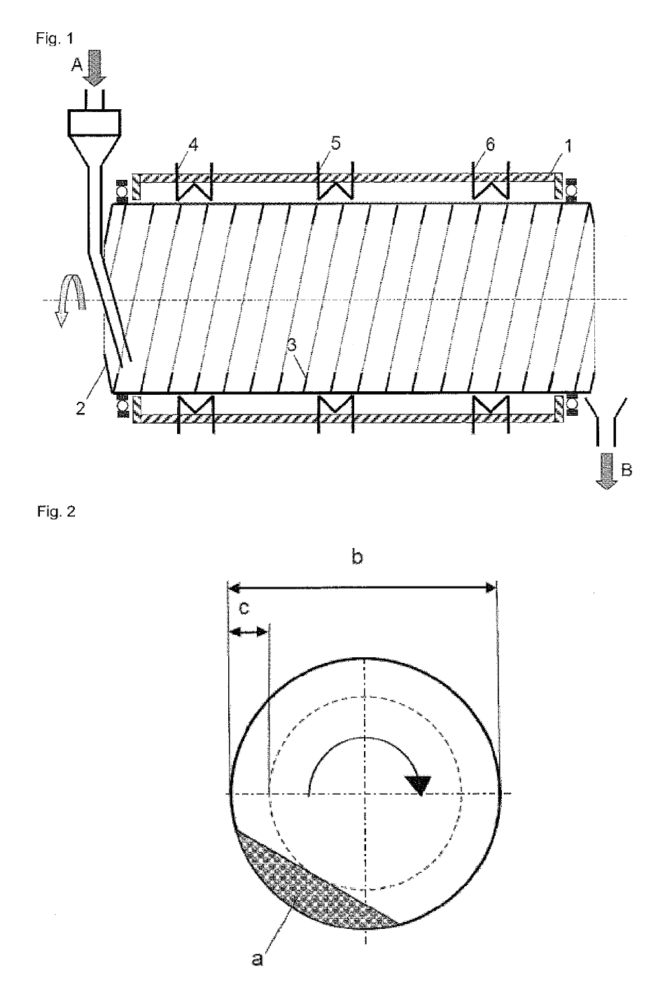

FIG. 1 shows a drum heat exchanger with indirect heating.

FIG. 2 shows a section through the drum heat exchanger.

The reference numerals in the figures have the following meanings:
A product inlet
B product outlet
1 static jacket (insulated)
2 rotating drum
3 inverse screw helix
4 zone 1 heating (electrical or steam)
5 zone 2 heating (electrical or steam)
6 zone 3 heating (electrical or steam)
a product
b internal diameter of the drum
c height of the screw helix

The drum preferably has a length of 3 to 30 m, more preferably of 5 to 25 m and most preferably of 7 to 20 m. The internal diameter of the drum is preferably from 0.3 to 10 m, more preferably from 0.4 to 5 m and most preferably from 1 to 3 m.

The screw helix has a height of preferably 0.05 to 1 m, more preferably of 0.1 to 0.8 m and most preferably of 0.2 to 0.6 m. The lead of the screw helix is preferably from 0.05 to 0.5 m, more preferably from 0.1 to 0.4 m and most preferably from 0.15 to 0.3 m. The height of the screw helix is the distance between the inner drum wall and the highest point on the screw helix in the direction of the axis of rotation. The lead of the screw helix is the offset of the screw helix in longitudinal direction in the case of a full rotation.

The peripheral speed of the drum is preferably from 0.02 to 0.5 m/s, more preferably from 0.03 to 0.3 m/s and most preferably from 0.04 to 0.15 m/s.

The maximum fill level of the drum heat exchanger with an inverse screw helix is the fill level at which there is only just no passage of product over the height of the screw helix into the next helix. FIG. 2 shows the maximum fill level. This fill level corresponds to a fill level of 100%.

The pitch of the longitudinal axis of the drum heat exchanger with an inverse screw helix relative to the horizontal is preferably +10 to −10°, more preferably +5 to −5° and most preferably +1 to

−1°, the positive sign meaning an upward pitch in conveying direction and the negative sign meaning a downward pitch in conveying direction.

In a preferred embodiment of the present invention, the water-absorbing polymer particles are cooled after the thermal surface postcrosslinking. The cooling is preferably performed in contact coolers, such as paddle coolers and disk coolers. Suitable coolers are, for example, Hosokawa Bepex® Horizontal Paddle Coolers (Hosokawa Micron GmbH; Leingarten; Germany), Hosokawa Bepex® Disc Coolers (Hosokawa Micron GmbH; Leingarten; Germany), Holo-Flite® coolers (Metso Minerals Industries Inc.; Danville; USA) and Nara Paddle Coolers (NARA Machinery Europe; Frechen; Germany).

In the cooler, the water-absorbing polymer particles are cooled to 20 to 150° C., preferably 30 to 120° C., more preferably 40 to 100° C. and most preferably 50 to 80° C.

Subsequently, the surface postcrosslinked polymer particles can be classified again, excessively small and/or excessively large polymer particles being removed and recycled into the process.

To further improve the properties, the surface postcrosslinked polymer particles can be coated or remoisturized.

The remoisturizing is preferably performed at 30 to 80° C., more preferably at 35 to 70° C., most preferably at 40 to 60° C. At excessively low temperatures, the water-absorbing polymer particles tend to form lumps, and, at higher temperatures, water already evaporates to a noticeable degree. The amount of water used for remoisturizing is preferably from 1 to 10% by weight, more preferably from 2 to 8% by weight and most preferably from 3 to 5% by weight. The remoisturizing increases the mechanical stability of the polymer particles and reduces their tendency to static charging. The remoisturizing is advantageously performed in the cooler after the thermal surface postcrosslinking.

Suitable coatings for improving the free swell rate and the permeability of the swollen gel bed (SFC) are, for example, inorganic inert substances, such as water-insoluble metal salts, organic polymers, cationic polymers and di- or polyvalent metal cations. Suitable coatings for dust binding are, for example, polyols. Suitable coatings for counteracting the unwanted caking tendency of the polymer particles are, for example, zinc oxide, zinc carbonate, fumed silica, such as Aerosil® 200, and surfactants, such as Span® 20.

The water-absorbing polymer particles produced by the process according to the invention have a moisture content of preferably 0 to 15% by weight, more preferably 0.2 to 10% by weight and most preferably 0.5 to 8% by weight, the moisture content being determined by EDANA recommended test method No. WSP 230.2-05 “Mass Loss Upon Heating”.

The water-absorbing polymer particles produced by the process according to the invention have a proportion of particles having a particle size of 300 to 600 μm of preferably at least 30% by weight, more preferably at least 50% by weight and most preferably at least 70% by weight.

The water-absorbing polymer particles produced by the process according to the invention have a centrifuge retention capacity (CRC) of typically at least 15 g/g, preferably at least 20 g/g, more preferably at least 22 g/g, especially preferably at least 24 g/g and most preferably at least 26 g/g. The centrifuge retention capacity (CRC) of the water-absorbing polymer particles is typically less than 60 g/g. The centrifuge retention capacity (CRC) is determined by EDANA recommended test method No. WSP 241.2-05 “Fluid Retention Capacity in Saline, After Centrifugation”.

The water-absorbing polymer particles produced by the process according to the invention have an absorption under a pressure of 49.2 g/cm² of typically at least 15 g/g, preferably at least 20 g/g, more preferably at least 22 g/g, especially preferably at least 24 g/g and most preferably at least 26 g/g. The absorption under a pressure of 49.2 g/cm² of the water-absorbing polymer particles is typically less than 35 g/g. The absorption under a pressure of 49.2 g/cm² is determined analogously to EDANA recommended test method No. WSP 242.2-05 “Absorption Under Pressure, Gravimetric Determination”, except that a pressure of 49.2 g/cm² is established instead of a pressure of 21.0 g/cm².

### Methods:

The standard test methods described hereinafter and designated “WSP” are described in: “Standard Test Methods for the Nonwovens Industry”, 2005 edition, published jointly by the Worldwide Strategic Partners EDANA (Avenue Eugene Plasky, 157, 1030 Brussels, Belgium, www.edana.org) and INDA (1100 Crescent Green, Suite 115, Cary, N.C. 27518, USA, www.inda.org). This publication is available both from EDANA and from INDA.

The measurements should, unless stated otherwise, be conducted at an ambient temperature of 23±2° C. and a relative air humidity of 50±10%. The water-absorbing polymer particles are mixed thoroughly before the measurement.

### Residual Monomers

The residual monomer content of the water-absorbing polymer particles is determined by EDANA recommended test method WSP No. 210.2-05 “Residual Monomers”.

### Centrifuge Retention Capacity

The centrifuge retention capacity (CRC) is determined by EDANA recommended test method No. WSP 241.2-05 “Fluid Retention Capacity in Saline, After Centrifugation”.

Absorption Under a Pressure of 49.2 g/cm² (Absorption Under Load)

The absorption under a pressure of 49.2 g/cm² (AUL0.7 psi) is determined analogously to EDANA recommended test method No. WSP 242.2-05 “Absorption Under Pressure, Gravimetric Determination”, except that a pressure of 49.2 g/cm² (AUL0.7 psi) is established instead of a pressure of 21.0 g/cm² (AUL0.3 psi).

### Extractables

The content of extractables of the water-absorbing polymer particles is determined by EDANA recommended test method No. WSP 270.2-05 “Extractable”.

### Permeability (Saline Flow Conductivity)

The permeability (SFC) of a swollen gel layer under a pressure of 0.3 psi (2070 Pa) is, as described in EP 0 640 330 A1, determined as the gel layer permeability of a swollen gel layer of water-absorbing polymer particles, the apparatus described on page 19 and in FIG. 8 in the aforementioned patent application having been modified such that the glass frit (40) is not used, and the plunger (39) consists of the same polymer material as the cylinder (37) and now comprises 21 bores of equal size distributed homogeneously over the entire contact area. The procedure and evaluation of the measurement remain unchanged from EP 0 640 330 A1. The flow is detected automatically.

The permeability (SFC) is calculated as follows:

SFC[cm³s/g]=(Fg(t=0)xL0)/(dxAxWP),

where Fg(t=0) is the flow of NaCl solution in g/s, which is obtained using linear regression analysis of the Fg(t) data of the flow determinations by extrapolation to t=0, LO is the thickness of the gel layer in cm, d is the density of the NaCl solution in g/cm³, A is the area of the gel layer in cm², and WP is the hydrostatic pressure over the gel layer in dyn/cm².

### EXAMPLES

### Example 1

A base polymer was produced in a cocurrent spray drier with an integrated fluidized bed (27) and external fluidized bed (29) according to FIG. 1 of WO 2011/026876 A1. The cylindrical portion of the spray drier (5) had a height of 22 m and a diameter of 3.4 m. The internal fluidized bed (IFB) had a diameter of 3.0 m and a weir height of 0.4 m. The external fluidized bed (EFB) had a length of 3.0 m, a width of 0.65 m and a weir height of 0.5 m.

The drying gas was supplied to the tip of the spray drier via a gas distributor (3). The drying gas was partly recycled through a fabric filter (9) and a scrubbing column (12) (cycle gas). The drying gas used was nitrogen with an oxygen content of 1 to 5% by volume. Prior to commencement of the polymerization, the plant was purged with nitrogen down to an oxygen content of below 5% by volume. The gas rate in the cylindrical portion of the spray drier (5) was 16 170 kg/h. The pressure in the interior of the spray drier was 4 mbar below the ambient pressure.

The outlet temperature of the spray drier was, as described in FIG. 3 of WO 2011/026876 A1, measured at three sites at the lower end of the cylindrical portion. The three individual measurements (47) were used to calculate the mean outlet temperature. The cycle gas was heated and the metered addition of the monomer solution was commenced. From this time, the mean outlet temperature was regulated at 116° C. by adjustment of the gas inlet temperature by means of the heat exchanger (20).

The product was collected in the internal fluidized bed (27) up to the height of the weir. Via line (25), drying gas was supplied to the internal fluidized bed (27) with a temperature of 132° C. The gas rate in the internal fluidized bed (27) was 10 000 kg/h.

The offgas of the spray drier was supplied to the scrubbing column (12) via the fabric filter (9). The liquid level within the scrubbing column (12) was kept constant by pumping out excess liquid. The liquid within the scrubbing column (12) was cooled by means of the heat exchanger (13) and conveyed in countercurrent through the nozzles (11), such that the temperature within the scrubbing column (12) was regulated to 45° C. In order to scrub acrylic acid out of the offgas, the liquid in the scrubbing column (12) was alkalized by addition of sodium hydroxide solution.

The offgas from the scrubbing column was divided between lines (1) and (25). The temperatures were regulated by means of the heat exchangers (20) and (22). The heated drying gas was supplied to the spray drier via the gas distributor (3). The gas distributor consisted of a row of plates and had a pressure drop of 5 to 10 mbar according to the gas rate.

The product was transferred from the internal fluidized bed (27) by means of the rotary feeder (28) into the external fluidized bed (29). Via line (40), drying gas was supplied to the external fluidized bed (29) with a temperature of 60° C. The drying gas was air. The gas rate in the external fluidized bed (29) was 2500 kg/h.

The product was transferred from the external fluidized bed (29) by means of the rotary feeder (32) onto the sieve (33). By means of the sieve (33), particles with a particle size of greater than 3000 μm (agglomerates) were removed.

To prepare the monomer solution, acrylic acid was admixed first with triethoxylated glyceryl triacrylate (crosslinker) and then with 37.3% by weight aqueous sodium acrylate. By pumped circulation through a heat exchanger, the temperature of the monomer solution was kept at 10° C. In the pumped circulation system, a filter with a mesh size of 150 μm was disposed beyond the pump. The initiators were added to the monomer solution via lines (43) and (44) upstream of the static mixers (41) and (42). Sodium peroxodisulfate was supplied with a temperature of 20° C. via line (43), and Brüggolit® FF7 (Brüggemann Chemicals; Heilbronn; Germany) was supplied with a temperature of 5° C. via line (44). Each initiator was pumped in circulation and metered via regulating valves in each dropletizer unit. Beyond the static mixer (42) was disposed a filter with a mesh size of 100 μm. For metered addition of the monomer solution at the tip of the spray drier, as described in FIG. 4 of WO 2011/026876 A1, three dropletizer units were used.

A dropletizer unit consisted, as described in FIG. 5 of WO 2011/026876 A1, of an outer tube (51) and a dropletizer cassette (53). The dropletizer cassette (53) was connected by an inner tube (52). The inner tube (52) had a PTFE seal (54) at the end and could be pulled out for maintenance purposes during operation.

FIG. 6 of WO 2011/026876 A1 describes the inner structure of the dropletizer cassette. The temperature of the dropletizer cassette (61) was regulated at 25° C. by means of cooling water in the channels (59). The dropletizer cassette had 256 holes. The holes had a diameter of 2.5 mm at the inlet and a diameter of 170 μm at the outlet. The holes were arranged in 6 rows, and the distance between the holes in one row was 12.38 mm and the distance between the rows 14 mm. The dropletizer cassette (61) had a flow channel (60) free of dead spaces for homogeneous distribution of the premixed monomer solution and of the initiator solutions between the two dropletizer plates (57). The holes were divided between two dropletizer plates (57) each with 128 holes, which means that each of the two dropletizer plates (57) had three rows of holes. The two dropletizer plates (57) had an angled arrangement with an angle of 3°. Each dropletizer plate (57) was made of stainless steel (materials No. 1.4571) and had a length of 530 mm, a width of 76 mm and a thickness of 15 mm.

The feed to the spray drier comprised 10.25% by weight of acrylic acid, 32.75% by weight of sodium acrylate, 0.035% by weight of triethoxylated glyceryl triacrylate (purity approx. 85% by weight), 0.00285% by weight of Brüggolit® FF7 (Brüggemann Chemicals; Heilbronn; Germany), 0.266% by weight of sodium peroxodisulfate and water. Brüggolit® FF7 was used in the form of a 5% by weight aqueous solution and sodium peroxodisulfate was used in the form of a 15% by weight aqueous solution. The degree of neutralization was 71%. The feed per hole was 1.6 kg/h.

The resulting base polymer had a bulk density of 74.4 g/100 ml, a mean particle diameter of 392 μm, a width of the particle diameter distribution of 0.48, a mean sphericity of 0.91, a centrifuge retention capacity (CRC) of 21.4 g/g, an absorption under a pressure of 49.2 g/cm³ (AUL0.7 psi) of 17.9 g/g and a residual monomer content of 2.75% by weight.

### Example 2

For thermal surface postcrosslinking, 1300 g of base polymer from example 1 were coated in a Pflugschar® Lö5 plowshare mixer with heating jacket (Gebr. Lödige Maschinenbau GmbH, Paderborn, Germany) at approx. 23° C. and a shaft speed of 250 rpm by means of a two-phase spray nozzle with the following solution (based in each case on the base polymer):

0.10% by weight of 2-hydroxyethyl-2-oxazolidinone

0.10% by weight of 1,3-propanediol

1.00% by weight of 1,2-propanediol

1.00% by weight of water

3.00% by weight of aqueous aluminum trilactate solution (22% by weight)

After the spray application, the product temperature was increased to 185° C. and the reaction mixture was held at this temperature and a shaft speed of 60 revolutions per minute for a total of 150 minutes. Samples were taken after different times. Prior to analysis, all samples were sieved to a particle size of 150 to 850 μm.

TABLE 1
Influence of residence time

| Residence | | | | Extract- | Residual |
|---|---|---|---|---|---|
| time | CRC | AUL0.7 psi | SFC | ables | monomers |
| [min] | [g/g] | [g/g] | [10⁻⁷ cm³s/g] | [% by wt.] | [% by wt.] |
| 15 | 29.3 | 17.1 | 8 | 6.7 | 0.115 |
| 30 | 31.5 | 19.5 | 15 | 5.6 | 0.110 |
| 45 | 29.3 | 23.9 | 33 | 5.9 | 0.093 |
| 60 | 28.0 | 24.7 | 76 | 6.0 | 0.088 |
| 70 | 27.1 | 24.1 | 98 | 6.4 | 0.085 |
| 80 | 26.7 | 23.9 | 85 | 7.3 | 0.095 |
| 90 | 26.2 | 22.2 | 108 | 10.3 | 0.096 |
| 100 | 26.3 | 21.8 | 89 | 10.2 | 0.089 |
| 110 | 26.2 | 22.4 | 77 | 13.9 | 0.092 |
| 120 | 25.8 | 22.1 | 74 | 12.6 | 0.092 |
| 150 | 25.0 | 21.1 | 60 | 13.9 | 0.087 |

### Example 3

For thermal surface postcrosslinking, 1500 g of base polymer from example 1 were coated in a Pflugschar® Lö5 plowshare mixer with heating jacket (Gebr. Lödige Maschinenbau GmbH, Paderborn, Germany) at approx. 23° C. and a shaft speed of 250 rpm by means of a two-phase spray nozzle with the following solution (based in each case on the base polymer):

1.00% by weight of 1,3-propanediol

1.00% by weight of water

3.00% by weight of aqueous aluminum trilactate solution (22% by weight)

After the spray application, the product temperature was increased to 180° C. and the reaction mixture was held at this temperature and a shaft speed of 60 revolutions per minute for a total of 120 minutes. Samples were taken after different times. Prior to analysis, all samples were sieved to a particle size of 150 to 850 μm.

TABLE 2
Influence of residence time

| Residence | Product | | | |
|---|---|---|---|---|
| time | temperature | CRC | AUL0.7 psi | SFC |
| [min] | [° C.] | [g/g] | [g/g] | [10⁻⁷ cm³s/g] |
| 15 | 134 | 27.6 | 20.5 | 34 |
| 30 | 174 | 30.1 | 21.3 | 13 |
| 45 | 180 | 32.5 | 23.0 | 12 |
| 60 | 180 | 30.5 | 23.8 | 40 |
| 70 | 180 | 29.4 | 23.7 | 70 |
| 80 | 181 | 27.8 | 23.5 | 96 |
| 90 | 180 | 27.5 | 23.5 | 88 |
| 100 | 180 | 26.8 | 22.8 | 83 |
| 110 | 180 | 26.6 | 22.4 | 70 |
| 120 | 180 | 26.7 | 22.0 | 62 |

Examples 2 and 3 show the considerable influence of residence time on the outcome of the surface postcrosslinking. The permeability (SFC) passes through a pronounced maximum.

### Example 4

In a further experiment, the residence time distribution was determined in an apparatus used to date for thermal surface postcrosslinking. A Nara Paddle Dryer 1.6W (GMF Gouda, Waddinxveen, the Netherlands) and Hysorb® M7055 (BASF SE, Ludwigshafen, Germany) were used. The speed was 37 rpm and the weir height 87% (at 100%, the weir is at the same height as the upper edge of the paddle). The throughput of Hysorb® M7055 was 60 kg/h. At the inlet of the paddle drier, for this experiment, specially colored particles of the Hysorb® M7055 product (BASF SE, Ludwigshafen, Germany) were added and the distribution of the colored particles over time was analyzed at the outlet of the paddle drier. The frequency distribution was used to determine, by integration, the cumulative frequency distributions τ₁₀, τ₅₀ and τ₉₀ (τ₁₀ corresponds to 10% of the cumulative frequency distribution, etc.).

The following widths of the frequency distribution were determined:

T₉₀/τ₅₀=1.31

T₁₀/τ₅₀=0.78

The mean residence time (τ₅₀) was 42 minutes.

### Example 5

The procedure was as in example 4. The throughput was increased from 60 kg/h to 80 kg/h.

The following widths of the frequency distribution were determined:

T₉₀/τ₅₀=1.31

T₁₀/τ₅₀=0.79

The mean residence time (τ₅₀) was 34 minutes.

### Example 6

The procedure was as in example 4. The fill level was reduced by decreasing the weir height from 87 to 62%.

The following widths of the frequency distribution were determined:

T₉₀/τ₅₀=1.33

T₁₀/τ₅₀=0.77

The mean residence time (τ₅₀)) was 31 minutes.

### Example 7

The procedure was as in example 4. Instead of a paddle drier, a drum heat exchanger with an inverse screw helix was used. The drum heat exchanger had an internal diameter of 700 mm, a length of 6000 mm and 60 helix flights. The helix flights had a height of 100 mm and a lead of 100 mm. The speed was 0.9 rpm, the throughput was 108 kg/h and the fill level was 100% of the height of the screw helix.

The following widths of the frequency distribution were determined:

T₉₀/τ₅₀=1.07

T₁₀/τ₅₀=0.96

The mean residence time (τ₅₀) was 52 minutes.

### Example 8

The procedure was as in example 7. The speed was increased from 0.9 rpm to 2.5 rpm. The throughput was increased from 108 kg/h to 224 kg/h. The fill level was 72% of the height of the screw helix.

The following widths of the frequency distribution were determined:

T₉₀/τ₅₀=1.01

T₁₀/τ₅₀=0.99

The mean residence time (τ₅₀) was 24 minutes.

Examples 4 to 8 demonstrate the much narrower residence time distribution of the drum heat exchanger with an inverse screw helix.

1. A process for thermal surface postcrosslinking of water-absorbing polymer particles, the water-absorbing polymers produced by polymerizing an aqueous monomer solution or suspension comprising
a) at least one ethylenically unsaturated monomer which bears an acid group and may be at least partly neutralized,
b) at least one crosslinker,
c) at least one initiator,
d) optionally one or more ethylenically unsaturated monomer copolymerizable with the monomer mentioned under a) and
e) optionally one or more water-soluble polymer, comprising coating the polymer particles with an aqueous solution, deagglomerating the coated polymer particles, and thermally surface postcrosslinking the deagglomerated polymer particles using a drum heat exchanger with an inverse screw helix.

2. The process according to claim 1, wherein the coating and the deagglomeration are conducted in a horizontal mixer.

3. The process according to claim 1, wherein the coating is conducted in a vertical mixer and the deagglomeration in a horizontal mixer.

4. The process according to claim 1, wherein the coated polymer particles are dried during the deagglomeration.

5. The process according to claim 1, wherein the coated polymer particles are heated during the deagglomeration.

6. The process according to claim 1, wherein a fill level of the drum heat exchanger is 65 to 90%.

7. The process according to claim 1, wherein a temperature of the water-absorbing polymer particles in the drum heat exchanger is from 170 to 200° C. and/or a residence time of the water-absorbing polymer particles in the drum heat exchanger is from 30 to 60 minutes.

8. The process according to claim 1, wherein the drum heat exchanger is heated electrically or with steam.

9. The process according to claim 1, wherein monomer a) is acrylic acid partly neutralized to an extent of at least 95 mol %.

10. The process according to claim 1, wherein the water-absorbing polymers have a centrifuge retention capacity of at least 26 g/g.

11. An apparatus for thermal surface postcrosslinking of water-absorbing polymer particles comprising a heatable horizontal mixer, and a drum heat exchanger with an inverse screw helix.

12. The apparatus according to claim 11, wherein the horizontal mixer and the drum heat exchanger are connected in direct succession.

13. An apparatus for thermal surface postcrosslinking of water-absorbing polymer particles comprising a vertical mixer, a heatable horizontal mixer, and a drum heat exchanger with an inverse screw helix.

14. The apparatus according to claim 13, wherein the vertical mixer, the horizontal mixer, and the drum heat exchanger are connected in direct succession.

15. The apparatus according to claim 11, wherein a coolable horizontal mixer is connected directly downstream of the drum heat exchanger.

16. The apparatus according to claim 13, wherein a coolable horizontal mixer is connected directly downstream of the drum heat exchanger.
